(19) United States
(12) Patent Application Publication
(10) Pub. No.: US 2026/0050764 A1
(43) Pub. Date: Feb. 19, 2026

(54) Out-of-Distribution Fault Detection Method and System Based on Energy Propagation and Graph Learning

(71) Applicant: Beijing University of Civil Engineering and Architecture, Beijing (CN)

(72) Inventors: Yanxue WANG, Beijing (CN); Xinming LI, Beijing (CN); Wenhan LV, Beijing (CN); Jinrui ZHANG, Beijing (CN); Kehui ZHU, Beijing (CN); Jinchuan MA, Beijing (CN); Guanhua SHAO, Beijing (CN)

(21) Appl. No.: 19/188,533

(22) Filed: Apr. 24, 2025

(30) Foreign Application Priority Data
Aug. 15, 2024 (CN) 202411122543.0

(51) Int. Cl. G06N 3/042; G01M 7/02; G06N 3/0464

(52) U.S. Cl. CPC G06N 3/042; G01M 7/025; G06N 3/0464

(57) ABSTRACT

The present invention relates to the technical field of intelligent out-of-distribution fault detection for construction machinery, and discloses an out-of-distribution fault detection method and system based on energy propagation and graph learning, and the method includes: acquiring vibration acceleration signals in typical fault states, carrying out similarity calculation to obtain an adjacency matrix composed of the maximum mutual information coefficients, and taking the adjacency matrix as input in a graph neural network; carrying out feature extraction on the adjacency matrix through adopting a GraphSage graph convolution method, and generating each node representation; calculating an energy score of each node, and distinguishing between in-distribution data and out-of-distribution data; and enhancing out-of-distribution data confidence estimation for each node, and carrying out out-of-distribution data identification and out-of-distribution data detection under different working conditions of a rolling bearing.

### CROSS-REFERENCE TO RELATED APPLICATIONS

The present application claims priority to Chinese Patent Application No. 202411122543.0, filed on Aug. 15, 2024, the entire disclosure of which is incorporated herein by reference.

### TECHNICAL FIELD

The present invention relates to the technical field of intelligent out-of-distribution fault detection for construction machinery, and specifically relates to an out-of-distribution fault detection method and system based on energy propagation and graph learning.

### BACKGROUND

The present invention relates to the field of intelligent out-of-distribution fault detection for construction machinery. It is worth noting that, although a focus of the present research is on practices and theories of intelligent fault diagnosis for construction machinery devices in the field of performance health management, a defined problem framework goes far beyond that. The present research is not only applicable for fault diagnosis, but an application range further includes key problems of PHM, such as fault prediction and remaining useful life (RUL) estimation. Although the construction machinery devices are selected as main application scenes for the present research due to importance of the construction machinery devices in the field of construction engineering, problem definition and application potentiality of solutions, which are discussed in the present research are not limited thereto. Actually, these methods and theories may be easily transferred to other types of complex mechanical systems, such as industrial robots and automatic production lines, and even more widely applied to any device which requires high reliability and performance monitoring. Such high applicability stems from a deep understanding for essences of the problems and flexible applications for solution strategies, and emphasizes importance of cross-domain applicability and model universality. Through in-depth research on out-of-distribution data detection and processing methods, the aim is to provide a reliable, effective, and easily-extensible tool and framework for the PHM field and even for wider industrial applications, and promote applications and developments of intelligent systems in the real world.

With pursuit for sustainable and intelligent buildings, the construction machinery devices have become an important component of the modern construction industry. High-efficiency running of the construction machinery devices represents an innovative and cost-effective construction method, which coincides with global efforts to promote green buildings and reduce carbon emissions. However, from minor mechanical wear to major system faults, running efficiency of these complex construction machinery devices is often influenced by various faults. These faults not only result in a significant amount of downtime, but also cause significant economic losses, and hinder overall progress and quality of construction projects. Therefore, effective fault diagnosis strategies are crucial for proactive management for the construction machinery devices, and may guarantee running of the construction machinery devices at the optimal performance levels and make significant contributions to goals of the intelligent buildings and the sustainable buildings.

Rise of deep learning technologies has triggered revolutionary changes in many fields, especially due to outstanding capability in aspects of processing complex data and extracting key features, the deep learning technologies have been widely adopted. However, traditional deep learning still faces challenges in solving an out-of-distribution data (OOD) detection problem, due to the fact that most current deep learning methods implicitly assume that training data and testing data follow the same distribution, and model performance is validated on the basis of generalization for the testing data with the same distribution. Meanwhile, the most current methods are based on an assumption of independent generation for data samples (such as image identification with instances without interaction). Such premise hinders adaptability of the existing deep learning methods to graph structure data with mutual dependence. Therefore, exploration for relevant applications of graph neural networks (GNNs) represents an important shift in solving out-of-distribution data problems in data with intrinsic correlations and interconnections.

### SUMMARY

In view of the above problems, the present invention is proposed.

Therefore, the technical problem solved by the present invention is that:

in order to solve the above technical problems, the present invention provides the following technical solution: an out-of-distribution fault detection method based on energy propagation and graph learning includes: acquiring vibration acceleration signals in typical fault states, carrying out similarity calculation to obtain an adjacency matrix composed of the maximum mutual information coefficients, and taking the adjacency matrix as input in a graph neural network:
carrying out feature extraction on the adjacency matrix through adopting a GraphSage graph convolution method, and generating each node representation;
connecting a model between an energy function and probability density to obtain an energy function under a GNN framework, calculating an energy score of each node, setting an energy score threshold value, and distinguishing between in-distribution data and out-of-distribution data;
enhancing out-of-distribution data confidence estimation for each node, and carrying out out-of-distribution data identification and out-of-distribution data detection under different working conditions of a rolling bearing according to an intelligent out-of-distribution data diagnosis framework based on the energy scores;
the connecting a model between an energy function and probability density to obtain an energy function under a GNN framework includes that, in a deep learning model, a K-class classification problem is solved by means of a parameter function ƒ_{θ}: [symbol] represents a feature space of input data x, and each data point x is a D-dimensional vector; [symbol] represents an output logits space, and each logit vector hᵢ^{(s)} is a K-dimensional vector which corresponds to K classes: ƒ_{θ} represents a parameterized mapping function, and the parameter function ƒ_{θ} maps each data point x∈ [symbol] to k real values logits; and after S layers of graph convolution, the GNN model outputs a K-dimensional vector hᵢ^{(s)} as the logits of each node, and the logits is represented as:

$${f}_{θ} ( {x}_{i} , {𝒢}_{{x}_{i}} ) = {h}_{i}^{\{ S )}$$

where ƒ_{θ}(xᵢ, [symbol] ) represents the logits obtained through carrying out S layers of graph convolution on each data point, xᵢ represents an input feature vector of the ith node, and i represents an index of the node;
according to update rules of the GNN, [symbol] represents a function for predicting logits for S-order ego-graph which takes an instance x as a center, and θ represents a trainable parameter in the GNN model ƒ;
the logits is input into a softmax function to obtain a probability distribution, and the model is enabled to carry out a classification task; and under conditions of given x and, [symbol] , a condition probability of a target class y is represented as:

$${p}_{θ} ( y \vert x , {𝒢}_{x} ) = \frac{{e}^{{{f}_{θ} ( x , {𝒢}_{x} )}_{[ y ]}}}{{\sum }_{k = 1}^{K} {e}^{{{f}_{θ} ( x , {𝒢}_{x} )}_{[ y ]}}}$$

where pθ(y|x, [symbol] ) represents a probability that the node x is classified to be the class y, [symbol] represents a neighbor node of the node x and a connection relationship thereof, ƒ_{θ}(x, [symbol] ) represents output of the parameterized function ƒ_{θ} under an input feature x and graph structure information, [symbol] the output is a K-dimensional vector, and each component corresponds to one class of the logit; ƒ_{θ}(xᵢ, [symbol] )_{[y]} represents the yth index of, ƒ_{θ}(xᵢ, [symbol] ), K represents a total number of classified classes, [y] represents an element with an index y, and [k] represents an element with an index k;
the condition probability of the target class y is combined with an EBM model between the defined energy function and the probability density, and an energy function induced by the GNN model is obtained, and represented as:

$$E ( x , {𝒢}_{x} , y ; {f}_{θ} ) = - {{f}_{θ} ( x , {𝒢}_{x} )}_{[ y ]}$$

where E(x, [symbol] , y; ƒ_{θ}) represents an energy value obtained through calculation;
LogSumExp(·) of the logits of a GNN classifier is re-used for defining an energy function at the data point x, and the energy function is represented as:

$${E}_{θ} ( x , {𝒢}_{x} ; {f}_{θ} ) = - Log Sum {Exp}_{k} ( {{f}_{θ} ( x )}_{[ k ]} ) = - log {\sum }_{k = 1}^{K} {e}^{{{f}_{θ} ( x , {𝒢}_{x} )}_{[ k ]}}$$

where E(x, [symbol] , y; ƒ_{θ}) represents the energy function, ƒ_{θ}(x)_{[k]} represents the kth element in a vector calculated by the function ƒ_{θ} under input x and [symbol] , LogSumExp(·) represents a log-likelihood calculation function, and ƒ_{θ}(x, [symbol] )_{[k]} represents a component corresponding to the kth class in an output logit vector calculated by the parameterized function ƒ_{θ} under the input feature x and the graph structure information [symbol] ;
training a loss through a negative log-likelihood loss function is represented as:

$${ℒ}_{sup} = {𝔼}_{( x , {𝒢}_{x} , y ) \sim {D}_{in}^{train}} ( - log p ( y \vert x , {𝒢}_{x} ) ) = {\sum }_{i ∈ {ℐ}_{s}} ( - {{f}_{θ} ( {x}_{1} , {𝒢}_{{x}_{i}} )}_{[ {y}_{i} ]} + log {\sum }_{k = 1}^{K} {e}^{{{f}_{θ} ( {x}_{i} , {𝒢}_{{x}_{i}} )}_{[ k ]}} )$$

where [symbol] represents an expected value operator, Dᵢₙ^{train} represents a distribution of sampled labeled parts of training data, [symbol] represents labeled nodes, [symbol] represents a supervised training loss, ƒ_{θ}(xᵢ, [symbol] )_{[y]} represents a component corresponding to the yᵢth class in an output logit vector calculated by the parameterized function ƒ_{θ} under the input feature x and the graph structure information [symbol] , and ƒ_{θ}(xᵢ, [symbol] )_{[k]} represents a component corresponding to the kth class in an output logit vector calculated by the parameterized function ƒ_{θ} under the input feature x, and the graph structure information [symbol] ;
an energy score threshold value is set, an energy score of each node is calculated according to the energy function under the GNN framework, and in-distribution data and out-of-distribution data are distinguished; and
if the energy score is lower than the threshold value, the energy score belongs to the in-distribution data, and if the energy score is higher than the threshold value, the energy score belongs to the out-of-distribution data.

As a preferred solution for the out-of-distribution fault detection method based on energy propagation and graph learning, of the present invention, the vibration acceleration signals in the typical fault states include healthy H, an outer ring fault F1, an inner ring fault F2, a rolling body fault F3, an outer ring-rolling body composite fault F4, and an outer ring-inner ring-rolling body composite fault F5.

As a preferred solution for the out-of-distribution fault detection method based on energy propagation and graph learning, of the present invention, the carrying out similarity calculation includes that, the vibration acceleration signals B=[b₁, b₂ . . . , bₙ] and C=[c₁, c₂, . . . , cₙ] under different working conditions are acquired, subjected to discretization processing, and converted into discrete variables.

Mutual information between B and C is calculated, and variable pairs with the maximum mutual information are selected as candidates. The mutual information I(B,C) is represented as:

$$I ( B , C ) = {\sum }_{b ∈ B} {\sum }_{c ∈ C} p ( b , c ) log \frac{p ( b , c )}{p ( b ) p ( c )}$$

where I(B,C) represents a mutual information coefficient, p(b,c) represents a joint probability distribution function of time sequences B and C, p(b) represents an edge probability density function of B, p(c) represents an edge probability density function of C, b; represents the ith value of the time sequence B, c, represents ith value of the time sequence C, and i=1, 2, . . . , n. b represents a value of the discretized variable B, and c represents a value of the discretized variable C.

The maximum mutual information coefficient is adopted as a similarity evaluation indicator, the maximum mutual information coefficient value is obtained through carrying out normalization processing on candidate variables, a statistical quantity is defined to be a triplet (B, C, MIC), where B and C represent discretized versions of the input variables, and MIC represents the maximum mutual information coefficient corresponding to the discretized versions, and is represented as:

$$MIC ( B , C ) = {max}_{ℳ \cdot 𝒩 < ξ} \frac{I ( B , C )}{{log}_{2} min ( ℳ , 𝒩 )}$$

where MIC(B, C) represents the maximum mutual information coefficient, [symbol] represents a number of grids divided in directions B and C, and ξ represents a selection parameter.

A dimension of the adjacency matrix composed of the maximum mutual information coefficients is N×N, and is taken as input in the graph neural network, so that one-dimensional time sequence data is converted into graph data which can be identified by the graph neural network model, and the graph data is represented as:

$$ρ = [ \begin{matrix}{p}_{11} & {p}_{12} & … & {p}_{1 N} \\ ⋮ & ⋱ & & ⋮ \\ ⋮ & & ⋱ & ⋮ \\ {p}_{N 1} & {p}_{N 2} & … & {p}_{NN}\end{matrix} ]$$

Where ρ represents the adjacency matrix, and p_{NN} represents the maximum mutual information coefficient between two time points at the Nth time of the time sequences B and C. pᵢⱼ represents the maximum mutual information coefficient between a node i and a node j, is a similarity measure between the two nodes, and is taken as a weight coefficient of each edge, i=1, 2, . . . , N, and j=1, 2, . . . , N.

As a preferred solution for the out-of-distribution fault detection method based on energy propagation and graph learning, of the present invention, the carrying out feature extraction on the adjacency matrix through adopting a GraphSage graph convolution method, and generating each node representation includes that, node representations are generated through sampling and aggregating features of neighbor nodes, and a weighted average attention mechanism is introduced to carry out weighting processing on the features of the neighbor nodes, so that important feature information is highlighted.

It is assumed that hᵥ^{(s)} represents a node representation of a node v at the sth layer, C(v) represents a neighbor set of the node v, and an update formula for a node representation at the s+1th layer is:

$${h}_{v}^{( s + 1 )} = σ ( {W}^{( s )} \cdot Aggregate ( \{ {h}_{v}^{( s )} \} ⋃ \{ {h}_{u}^{( s )} , ∀ u ∈ 𝒞 ( v ) \} ) )$$

where hᵥ^{(s+1)} represents a node representation of the node v at the s+1th layer, σ represents a nonlinear activation function, W^{(s)} represents a weight matrix of the sth layer, hᵤ^{(s)} represents a node representation of a node u at the sth layer, and Aggregate represents a mean value aggregation function, and is represented as:

$$Aggregate ( \{ {h}_{v}^{( s )} \} ⋃ \{ {h}_{u}^{( s )} , ∀ u ∈ 𝒞 ( v ) \} ) = \frac{1}{\vert 𝒞 ( v ) \vert + 1} {\sum }_{u ∈ \{ v \} ⋃ 𝒞 ( v )} {h}_{u}^{( s )}$$

attention weights obtained are normalized through the Softmax function to obtain aᵥᵤ, and feature aggregation is carried out through the weighted average attention mechanism to obtain an updated node representation:

$${h}_{v}^{( s + 1 )} = σ ( {\sum }_{u ∈ 𝒞 ( v )} {α}_{vu} {Wh}_{u}^{( s )} ) = σ ( {\sum }_{u ∈ 𝒞 ( v )} {α}_{vu} {W}^{( s )} ( \frac{1}{\vert 𝒞 ( v ) \vert + 1} {\sum }_{u ∈ \{ v \} ⋃ 𝒞 ( v )} {h}_{u}^{( s )} ) )$$

where aᵥᵤ represents a result after normalizing the attention weights, W represents the weight matrix, and h represents the node representation.

As a preferred solution for the out-of-distribution fault detection method based on energy propagation and graph learning, of the present invention, the enhancing out-of-distribution data confidence estimation for each node includes that, E⁽⁰⁾=[E(xᵢ, [symbol] ; ƒ_{θ})]_{i∈I} is defined to be an initial energy score vector of a node vᵢ in a graph, E⁽⁰⁾ represents the initial energy score vector of the node vᵢ in the graph, E(xᵢ, [symbol] ; F_{θ}) represents an energy function which is used for calculating an energy value of the node, and through a propagation update rule, the energy value is represented as:

$${E}^{( s )} = λ {E}^{( s - 1 )} + ( 1 - λ ) {D}^{- 1} {AE}^{( s - 1 )} , {E}^{( s )} = {[ {E}_{i}^{( s )} ]}_{i ∈ ℐ}$$

where 0<λ<1 represents a parameter which controls energy transmission between the node and other connected nodes to be concentrated. E^{(s)} represents an energy score vector of the node at the sth layer, E^{(s-1)} represents an energy score vector of the node at the sth layer, D represents a degree matrix, A represents the adjacency matrix, [symbol] represents all node domains, and Eᵢ^{(s)} represents an energy value of the ith node after the sth iteration.

According to a propagation rule for the updated nodes, after S-step propagation, a final result

$$\tilde{E} ( {x}_{i} , {𝒢}_{{x}_{i}} ; {f}_{θ} ) = {E}_{i}^{( S )}$$

after the energy transmission is obtained, where \tilde{E}(xᵢ, [symbol] ; ƒ_{θ}) represents a final energy value of the node i after S-step propagation iteration, and out-of-distribution data detection and judgment are carried out on the final result after the energy transmission.

The transmission of energy in a graph topology structure enhances out-of-distribution data confidence estimation for each node by means of the energy values of adjacent nodes, and with regard to any given data sample point xᵢ, if an average energy score

$$\frac{{\sum }_{j} {a}_{ij} {E}_{j}^{( s - 1 )}}{{\sum }_{j} {a}_{ij}}$$

of a one-hop neighbor node of the data sample point is lower than an own energy score Eᵢ^{(k-1)} of the data sample point, which is represented as:

$$\frac{{\sum }_{j} {a}_{ij} {E}_{j}^{( s - 1 )}}{{\sum }_{j} {a}_{ij}} < {E}_{i}^{( s - 1 )}$$

it is obtained according to the propagation update rule E^{(s)} that:

$$\begin{matrix}{E}_{i}^{( s )} = λ {E}_{i}^{( s - 1 )} + ( 1 - λ ) \frac{{\sum }_{j} {a}_{ij} {E}_{j}^{( s - 1 )}}{{\sum }_{j} {a}_{ij}} \\ < λ {E}_{i}^{( s - 1 )} + ( 1 - λ ) {E}_{i}^{( s - 1 )} \\ = {E}_{i}^{( s - 1 )}\end{matrix}$$

where Eᵢ^{(s)} represents a node energy score vector of the node i at the sth layer, aᵢⱼ represents a weight of a direct connection edge of the node i and the node j, and Eᵢ^{(s-1)} represents a node energy score vector of the node i at the s−1th layer.

a judgment criteria of an out-of-distribution data discriminator is represented as:

$$G ( x , {𝒢}_{x} ; {f}_{θ} ) = \{ \begin{matrix}1 , & if \tilde{E} ( x , {𝒢}_{x} ; {f}_{θ} ) \leq ε , \\ 0 , & if \tilde{E} ( x , {𝒢}_{x} ; {f}_{θ} ) > ε ,\end{matrix}$$

where G(x, [symbol] ; ƒ_{θ}) represents a binary classification function which judges whether the input x belongs to the in-distribution data or the out-of-distribution data, ε represents a judgment threshold value, and \tilde{E}(xᵢ, [symbol] ; ƒ_{θ}) represents the final result after the energy transmission.

As a preferred solution for the out-of-distribution fault detection method based on energy propagation and graph learning, of the present invention, the carrying out out-of-distribution data identification and out-of-distribution data detection under different working conditions of a rolling bearing according to an intelligent out-of-distribution data diagnosis framework based on the energy scores includes four steps of graph construction, feature encoding, energy score detection, and energy propagation update.

The graph construction includes converting the vibration signals acquired by a sensor into graph data by means of the maximum mutual information coefficient, and constructing the adjacency matrix which reflects a nonlinear relationship among faults.

The feature encoding includes carrying out feature extraction on the graph data through adopting a GraphSage model and the weighted average attention mechanism. The GraphSage generates the node representations through aggregating the features of the neighbor nodes, and the attention mechanism strengthens weights of important neighbor features to enhance representation capability of the model.

The energy score detection includes introducing out-of-distribution data discrimination based on the energy scores, and establishing the energy function for the data points through re-defining the logits of the classifier. In-distribution data and out-of-distribution data are distinguished through calculating the energy scores, and effective out-of-distribution data fault detection is realized.

The energy propagation update includes improving generalization capability of the model in a semi-supervised learning environment, and proposes an energy score propagation mechanism based on a graph structure. The energy values are updated by means of neighbor node information and through iteratively propagating the energy scores of the nodes in the graph, and an energy difference between the in-distribution data and the out-of-distribution data is strengthened, so that accuracy of out-of-distribution data detection is increased.

An out-of-distribution fault detection system based on energy propagation and graph learning includes:

an acquisition module used for acquiring vibration acceleration signals in typical fault states, carrying out similarity calculation to obtain an adjacency matrix composed of the maximum mutual information coefficients, and taking the adjacency matrix as input in a graph neural network:
a feature extraction module used for carrying out feature extraction on the adjacency matrix through adopting a GraphSage graph convolution method, and generating each node representation;
an energy score calculation module used for connecting a model between an energy function and probability density to obtain an energy function under a GNN framework, calculating an energy score of each node, setting an energy score threshold value, and distinguishing between in-distribution data and out-of-distribution data; and
an optimization module used for enhancing out-of-distribution data confidence estimation for each node, and carrying out out-of-distribution data identification and out-of-distribution data detection under different working conditions of a rolling bearing according to an intelligent out-of-distribution data diagnosis framework based on the energy scores.

A computer device includes a memory and a processor, where the memory stores a computer program, and the steps of the above method are realized when the processor executes the computer program.

A computer-readable storage medium in which a computer program is stored, where the steps of the above method are realized when the computer program is executed by a processor.

The beneficial effects of the present invention are that: the present patent proposes an innovative energy-driven graph neural out-of-distribution detection framework aimed at addressing a challenge of out-of-distribution data in complex and dynamic environments. The framework effectively captures complex fault correlations by means of the graph neural network and the energy-based model, and increases accuracy of fault diagnosis. The framework converts the vibration signals collected by the sensor into the graph data through adopting the maximum information coefficient, and creates the adjacency matrix which represents the nonlinear relationship among the various fault types. In addition, the framework includes an out-of-distribution data detection module based on the energy scores, and the module re-defines the logits of the classifier to establish the energy function, so that accurate distinguishing between the in-distribution (ID) data and the out-of-distribution data (OOD) is realized. In order to further enhance robustness of the model in the semi-supervised environment, an energy score update scheme based on the propagation mechanism iteratively optimizes the energy values in the graph. An experiment carried out on a custom-built wear monitoring platform for a bearing of a mechanical device has validated superior performance of the framework in an aspect of detecting and diagnosing various fault conditions. A result indicates that, the framework is high in generalization capability and detection accuracy, provides a strong technical support for intelligent diagnosis for the construction machinery, and promotes intelligent and sustainable construction practices.

### BRIEF DESCRIPTION OF DRAWINGS

In order to describe the technical solutions of the examples of the present invention more clearly, a brief introduction for the drawings required in the description for the examples will be provided below, apparently, the drawings in the description below show merely some examples of the present invention, and those of ordinary skill in the art may also derive other drawings from these drawings without making creative efforts. In the drawings:

FIG. 1 is an overall flow diagram of an out-of-distribution fault detection method and system based on energy propagation and graph learning, which are provided by a first example of the present invention; and

FIG. 2 is a diagram of influence of different graph construction methods of an out-of-distribution fault detection method and system based on energy propagation and graph learning, which are provided by a second example of the present invention, on performance of a model.

### DETAILED DESCRIPTION OF THE EMBODIMENTS

In order to make the above objectives, features, and advantages of the present invention more apparent and understandable, the specific implementation manners of the present invention are described below in detail in conjunction with the drawings of the present invention, and apparently, the examples described are merely a part rather than all of the examples of the present invention. On the basis of the examples of the present invention, all other examples obtained by those of ordinary skill in the art without creative efforts shall fall within the protection scope of the present invention.

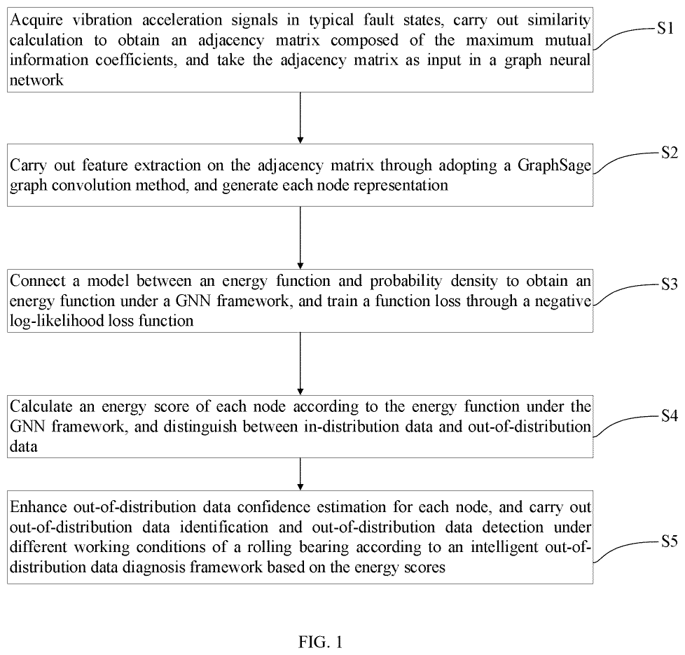

Example 1, FIG. 1 shows an example of the present invention, the example provides an out-of-distribution fault detection method based on energy propagation and graph learning, and the method includes:

S1: acquiring vibration acceleration signals in typical fault states, carrying out similarity calculation to obtain an adjacency matrix composed of the maximum mutual information coefficients, and taking the adjacency matrix as input in a graph neural network.

The vibration acceleration signals in the typical fault states include healthy H, an outer ring fault F1, an inner ring fault F2, a rolling body fault F3, an outer ring-rolling body composite fault F4, and an outer ring-inner ring-rolling body composite fault F5.

The vibration acceleration signals B=[b₁, b₂, . . . , bₙ] and C=[c₁, c₂, . . . , cₙ] and under different working conditions are acquired, subjected to discretization processing, and converted into discrete variables.

Mutual information between B and C is calculated, and variable pairs with the maximum mutual information are selected as candidates. The mutual information I(B,C) is represented as:

$$I ( B , C ) = {\sum }_{b ∈ B} {\sum }_{c ∈ C} p ( b , c ) log \frac{p ( b , c )}{p ( b ) p ( c )}$$

where I(B,C) represents a mutual information coefficient, p(b,c) represents a joint probability distribution function of time sequences B and C, p(b) represents an edge probability density function of B, p(c) represents an edge probability density function of C, bᵢ represents the ith value of the time sequence B, c, represents ith value of the time sequence C, and i=1, 2, . . . , n. b represents a value of the discretized variable B, and c represents a value of the discretized variable C.

The maximum mutual information coefficient is adopted as a similarity evaluation indicator, the maximum mutual information coefficient value is obtained through carrying out normalization processing on candidate variables, a statistical quantity is defined to be a triplet (B, C, MIC), where B and C are discretized versions of the input variables, and MIC is the maximum mutual information coefficient corresponding to the discretized versions, and is represented as:

$$MIC ( B , C ) = {max}_{ℳ * 𝒩 < ξ} \frac{I ( B , C )}{{log}_{2} min ( ℳ , 𝒩 )}$$

where MIC(B,C) represents the maximum mutual information coefficient, [symbol] represents a number of grids divided in directions B and C, and ξ represents a selection parameter.

It should be noted that, ξ=n^{0.6} is selected in the present invention.

A dimension of the adjacency matrix composed of the maximum mutual information coefficients is N×N, and is taken as input in the graph neural network, so that one-dimensional time sequence data is converted into graph data which can be identified by the graph neural network model, and the graph data is represented as:

$$ρ = [ \begin{matrix}{p}_{11} & {p}_{12} & … & {p}_{1 N} \\ ⋮ & ⋱ & & ⋮ \\ ⋮ & & ⋱ & ⋮ \\ {p}_{N 1} & {p}_{N 2} & … & {p}_{NN}\end{matrix} ]$$

Where ρ represents the adjacency matrix, and p_{NN} represents the maximum mutual information coefficient between two time points at the Nth time of the time sequences B and C. pᵢⱼ represents the maximum mutual information coefficient between a node i and a node j, is a similarity measure between the two nodes, and is taken as a weight coefficient of each edge, i=1, 2, . . . , N, and j=1, 2, . . . . N.

S2: carrying out feature extraction on the adjacency matrix through adopting a GraphSage graph convolution method, and generating each node representation.

It should be noted that, GraphSage, as a flexible and highly-extensible graph convolution method, generates node representations through sampling and aggregating features of neighbor nodes. A core idea is to sample a fixed number of neighbors in each layer, and aggregate features of these neighbors to generate node features with higher representation capabilities. Such aggregation manner can effectively capture structure information and features of a node and neighbors of the node, and is especially applicable for large-scale graph data, and meanwhile, GraphSage convolution layers may aggregate the information of local neighbors at each layer, so that layer-by-layer extraction and integration for local features are contributed, and then final features of the node can reflect local structures and feature distribution of the node.

It is assumed that hᵥ^{(s)} represents a node representation of a node ν at the sth layer, C(v) represents a neighbor set of the node v, and an update formula for a node representation at the s+1th layer is:

$${h}_{v}^{( s + 1 )} = σ ( {W}^{( s )} \cdot Aggregate ( \{ {h}_{v}^{( s )} \} ⋃ \{ {h}_{u}^{( s )} , ∀ u ∈ 𝒞 ( v ) \} ) )$$

where hᵥ^{(s+1)} represents a node representation of the node v at the s+1th layer, σ represents a nonlinear activation function, W(s) represents a weight matrix of the sth layer, hᵤ^{(s)} represents a node representation of a node u at the sth layer, and Aggregate represents a mean value aggregation function, and is represented as:

$$Aggregate ( \{ {h}_{v}^{( s )} \} ⋃ \{ {h}_{u}^{( s )} , ∀ u ∈ 𝒞 ( v ) \} ) = \frac{1}{\vert 𝒞 ( v ) \vert + 1} {\sum }_{u ∈ \{ v \} ⋃ 𝒞 ( v )} {h}_{u}^{( s )}$$

Further, in a graph neural network, complex relationships among the nodes may not be sufficiently captured only by means of simple feature aggregation. For this purpose, in the present invention, a weighted average attention mechanism is introduced to carry out weighting processing on the features of the neighbor nodes, so that important feature information is highlighted. A basic idea of the weighted average attention mechanism is to learn attention weights between each node and the neighbor nodes of the node, so that important features of the neighbor nodes occupy a higher proportion in the aggregation process. The attention weights obtained are normalized through the Softmax function to obtain aᵥᵤ. Finally, feature aggregation is carried out through the weighted average attention mechanism to obtain an updated node representation:

$$\text{?} = σ ( \text{?} {α}_{vu} \text{?} ) = σ ( \text{?} {α}_{vu} {W}^{( s )} ( \frac{1}{\vert 𝒞 ( v ) \vert + 1} \text{?} ) )$$

$$\text{?} \text{indicates text missing or illegible when filed}$$

where aᵥᵤ represents a result after normalizing the attention weights, W represents the weight matrix, and h represents the node representation.

Furthermore, through the above process, the feature encoder can effectively capture complex dependency relationships among the nodes, and realize high-efficiency feature extraction and processing in heterogeneous graph data. Such method not only enhances the representation capability for the node features, but also improves robustness of the model while processing complex graph structures and heterogeneous graph data. Through the weighted average attention mechanism, the model can dynamically adjust importance of each node feature, so that information transmission is more accurate, and then accuracy and reliability of fault diagnosis are further improved. In addition, in combination with extendibility of the GraphSage and flexibility of the attention mechanism, the feature encoder proposed by the present invention provides a new solution for high-efficiency processing for large-scale graph data, and has a wide application prospect.

S3: connecting a model between an energy function and probability density to obtain an energy function under a GNN framework, and training a function loss through a negative log-likelihood loss function. An energy score of each node is calculated according to the energy function under the GNN framework, and in-distribution data and out-of-distribution data are distinguished.

In a deep learning model, a K-class classification problem is solved by means of a parameter function ƒ_{θ}: [symbol] represents a feature space of input data x, and each data point x is a D-dimensional vector. [symbol] represents an output logits space, and each logit vector hᵢ^{(s)} is a K-dimensional vector which corresponds to K classes. ƒ_{θ} represents a parameterized mapping function, and the parameter function ƒ_{θ} maps each data point x∈ [symbol] to k real values logits. After S layers of graph convolution, the GNN model outputs a K-dimensional vector hᵢ^{(s)} as the logits of each node, and the logits is represented as:

$${f}_{θ} ( {x}_{i} , {𝒢}_{{x}_{i}} ) = {h}_{i}^{( S )}$$

where ƒ_{θ}(xᵢ, [symbol] ) represents the logits obtained through carrying out S layers of graph convolution on each data point, xᵢ represents an input feature vector of the ith node, and i represents an index of the node.

According to update rules of the GNN, [symbol] represents a function for predicting logits for S-order ego-graph which takes an instance x as a center, and θ represents a trainable parameter in the GNN model ƒ.

The logits is input into a softmax function to obtain a probability distribution, and the model is enabled to carry out a classification task. Under conditions of given x and [symbol] , a condition probability of a target class y is represented as:

$${p}_{θ} ( y \vert x , {𝒢}_{x} ) = \frac{{e}^{{{f}_{θ} ( x , {𝒢}_{x} )}_{[ y ]}}}{{\sum }_{k = 1}^{K} {e}^{{{f}_{θ} ( x , {𝒢}_{x} )}_{[ k ]}}}$$

where p_{θ}(y|x, [symbol] ) represents a probability that the node x is classified to be the class y, [symbol] represents a neighbor node of the node x and a connection relationship thereof, ƒ_{θ}(x, [symbol] ) represents output of the parameterized function ƒ_{θ} under an input feature x and graph structure information, the output is a K-dimensional vector, and each component corresponds to one class of the logit. ƒ_{θ}(xᵢ, [symbol] )_{[y]} represents the yth index of ƒ_{θ}(xᵢ, [symbol] ), K represents a total number of classified classes, [y] represents an element with an index y, and [k] represents an element with an index k.

the condition probability of the target class y is combined with an EBM model between the defined energy function and the probability density, and an energy function induced by the GNN model is obtained, and represented as:

$$E ( x , {𝒢}_{x} , y ; {f}_{θ} ) = - {{f}_{θ} ( x , {𝒢}_{x} )}_{[ y ]}$$

where E(x, [symbol] , y; ƒ_{θ}) represents an energy value obtained through calculation.

It should be noted that, the energy values given above are directly obtained from the predicted logits of the GNN classifier, that is to say, relevant parameters of the GNN do not need to be changed.

LogSumExp(·) of the logits of a GNN classifier is re-used for defining an energy function at the data point x, and the energy function is represented as:

$${E}_{θ} ( x , {𝒢}_{x} ; {f}_{θ} ) = - Log Sum {Exp}_{k} ( {{f}_{θ} ( x )}_{[ k ]} ) = - log {\sum }_{k = 1}^{K} {e}^{{{f}_{θ} ( x , {𝒢}_{x} )}_{[ k ]}}$$

where E_{θ}(x, [symbol] ; ƒ_{θ}) represents the energy function, ƒ_{θ}(x)_{[k]} represents the kth element in a vector calculated by the function ƒ_{θ} under input x and [symbol] , LogSumExp(·) represents a log-likelihood calculation function, and ƒ_{θ} (x, [symbol] )_{[k]} represents a component corresponding to the kth class in an output logit vector calculated by the parameterized function ƒ_{θ} under the input feature x and the graph structure information [symbol] .

Further, in deep learning, the negative log-likelihood loss function is usually used for a classification task, and especially in a multi-class classification problem. The negative log-likelihood loss function measures a difference between a prediction of the model for observed data and an actual label, that is, a difference between a predicted probability distribution of the model and a probability distribution of a true label. When a negative log-likelihood loss is used for training, the model is overly confident in prediction for the in-distribution data, that is, energy of in-distribution data samples is reduced. Therefore, for a node classification model, the GNN model usually trains, i.e., supervises a training loss through adopting negative log-likelihood which minimizes labeled training data, and the process is specifically as follows:

$${ℒ}_{sup} = {𝔼}_{( x , {𝒢}_{x} , y ) ∼ {𝒟}_{in}^{train}} ( - log p ( y \vert x , {𝒢}_{x} ) ) = {\sum }_{i ∈ {ℐ}_{i}} ( - {{f}_{θ} ( {x}_{i} , {𝒢}_{{x}_{i}} )}_{[ {y}_{i} ]} + log {\sum }_{k = 1}^{K} {e}^{{{f}_{θ} ( {x}_{i} , {𝒢}_{{x}_{i}} )}_{[ k ]}} )$$

where [symbol] represents an expected value operator, Dᵢₙ^{train} represents a distribution of sampled labeled parts of training data, [symbol] represents labeled nodes, [symbol] represents a supervised training loss, ƒ_{θ}(xᵢ, [symbol] )_{[y}_{ᵢ}_{]} represents a component corresponding to the yᵢth class in an output logit vector calculated by the parameterized function ƒ_{θ} under the input feature x and the graph structure information [symbol] , and ƒ_{θ}(xᵢ, [symbol] )_{[k]} represents a component corresponding to the kth class in an output logit vector calculated by the parameterized function ƒ_{θ} under the input feature x, and the graph structure information [symbol] .

An energy score threshold value is set, an energy score of each node is calculated according to the energy function under the GNN framework, and in-distribution data and out-of-distribution data are distinguished.

If the energy score is lower than the threshold value, the energy score belongs to the in-distribution data. If the energy score is higher than the threshold value, the energy score belongs to the out-of-distribution data.

It should be noted that, in energy-based out-of-distribution detection, setting of the threshold value τ is a key step that directly influences capability of distinguishing between the in-distribution data and the out-of-distribution data, of the model. The step of setting the threshold value includes training the GNN model by means of training data. In a training process, the model will learn how to map input data to output energy scores. The training data usually includes the in-distribution data. For the trained model, an energy score of each sample is calculated in a validation set. On the basis of a distribution of the validation set: a distribution of the energy scores is calculated in the validation set. Usually, a demarcation point enabling most of the energy scores of in-distribution samples to be low and enabling the energy scores of out-of-distribution samples to be high is usually selected as the threshold value. For example, a point enabling 95% of the energy scores of the in-distribution samples to be lower than the threshold value may be selected. Once the threshold value t is determined, in a testing phase, for each testing sample, the energy score of the testing sample is calculated and compared with the threshold value. If the energy score is lower than the threshold value, the sample is considered to belong to the in-distribution data. If the energy score is higher than the threshold value, the sample is considered to belong to the out-of-distribution data.

Furthermore, for example, it is assumed that the distribution of the energy scores calculated in the validation set is that the energy scores of the in-distribution data are mostly within a range of [−5, −1]. The energy scores of the out-of-distribution data are mostly within a range of [0, 5]. Then a value between −1 and 0) is selected as the threshold value, such as τ=−0.5, so that the in-distribution data and the out-of-distribution data may be effectively distinguished.

S4: enhancing out-of-distribution data confidence estimation for each node, and carrying out out-of-distribution data identification and out-of-distribution data detection under different working conditions of a rolling bearing according to an intelligent out-of-distribution data diagnosis framework based on the energy scores.

It should be noted that, due to the fact that the labeled data is usually scarce in a semi-supervised learning environment, the energy scores obtained directly from the GNN model trained in the labeled data by means of the supervised loss may not be sufficient to greatly promote judgment for types of the input data. Therefore, the key to enhancing the generalization capability of the GNN model lies in how to utilize unlabeled data in the training set for contributing the model to better identify the graph topology structure behind the data. Inspired by a classic non-parametric semi-supervised learning algorithm-label propagation, an energy score update scheme based on a propagation mechanism is proposed, and the energy scores obtained by the nodes are iteratively propagated among the interconnected nodes in the observed graph topology structure.

E⁽⁰⁾[E(xᵢ, [symbol] ; ƒ_{θ}) [symbol] is defined to be an initial energy score vector of a node vᵢ in a graph, E⁽⁰⁾ represents the initial energy score vector of the node vᵢ in the graph, E(xᵢ, [symbol] ; ƒ_{θ}) represents an energy function which is used for calculating an energy value of the node, and through a propagation update rule, the energy value is represented as:

$${E}^{( s )} = λ {E}^{( s - 1 )} + ( 1 - λ ) {D}^{- 1} {AE}^{( s - 1 )} , {E}^{( s )} = {[ {E}_{i}^{( s )} ]}_{i ∈ ℐ}$$

where 0<λ<1 represents a parameter which controls energy transmission between the node and other connected nodes to be concentrated. E^{(s)} represents an energy score vector of the node at the sth layer, E^{(s-1)} represents an energy score vector of the node at the sth layer, D represents a degree matrix, A represents the adjacency matrix, [symbol] represents all node domains, and Eᵢ^{(s)} represents an energy value of the ith node after the sth iteration.

According to a propagation rule for the updated nodes, after S-step propagation, a final result

$$\tilde{E} ( {x}_{i} , {𝒢}_{{x}_{i}} ; {f}_{θ} ) = {E}_{i}^{( S )}$$

after the energy transmission is obtained, where \tilde{E}(xᵢ, [symbol] ; ƒ_{θ}) represents a final energy value of the node i after S-step propagation iteration, and out-of-distribution data detection and judgment are carried out on the final result after the energy transmission.

It should be noted that, a basic principle behind the energy score update scheme based on the propagation mechanism is to adapt to a physical mechanism and instance interaction in data generation. Due to the fact that an input graph may reflect a geometric structure among the data samples with certain similarity in a manifold, and it is natural for all generation for the nodes and prediction for unknown node labels to be conditional on the neighbors of the nodes, the nodes with connection relationships are often sampled from similar distributions. In consideration of that the energy function at the data point x is an effective judgment basis for the out-of-distribution data, and the propagation of the energy scores in a space basically imitates such physical mechanism of data generation, so that confidence of out-of-distribution data detection is enhanced. Meanwhile, the transmission of energy in a graph topology structure may enhance out-of-distribution data confidence estimation for each node by means of the energy values of adjacent nodes, and with regard to any given data sample point xᵢ, if an average energy score

$$\frac{{\sum }_{j} {a}_{ij} {E}_{j}^{( s - 1 )}}{{\sum }_{j} {a}_{ij}}$$

of a one-hop neighbor node of the data sample point is lower than an own energy score Eᵢ^{(k-1)} of the data sample point, which is represented as:

$$\frac{{\sum }_{j} {a}_{ij} {E}_{j}^{( s - 1 )}}{{\sum }_{j} {a}_{ij}} < {E}_{i}^{( s - 1 )}$$

it is obtained according to the propagation update rule E^{(s)} that:

$$\begin{matrix}{E}_{i}^{( s )} = λ {E}_{i}^{( s - 1 )} + ( 1 - λ ) \frac{{\sum }_{j} {a}_{ij} {E}_{j}^{( s - 1 )}}{{\sum }_{j} {a}_{ij}} \\ < λ {E}_{i}^{( s - 1 )} + ( 1 - λ ) {E}_{i}^{( s - 1 )} \\ = {E}_{i}^{( s - 1 )}\end{matrix} .$$

where Eᵢ^{(s)} represents a node energy score vector of the node i at the sth layer, aᵢⱼ represents a weight of a direct connection edge of the node i and the node j, and Eᵢ^{(s-1)} represents a node energy score vector of the node i at the s−1th layer.

Further, an opposite result may also be proven by means of a similar method

$$\frac{{\sum }_{j} {a}_{ij} {E}_{j}^{( s - 1 )}}{{\sum }_{j} {a}_{ij}} > {E}_{i}^{( s - 1 )} .$$

Therefore, the energy score update scheme based on the propagation mechanism may push the energy values towards most of surrounded nodes, that is, along with progress of the iterative propagation process, the energy values of the in-distribution data tend to the minimum while the energy values of the out-of-distribution data tend to the maximum, so that the model method may be contributed to amplify an energy difference value between the in-distribution samples and the out-of-distribution samples, and then judgment capability of the model is provided.

a judgment criteria of an out-of-distribution data discriminator is represented as:

$$G ( x , {𝒢}_{x} ; {h}_{θ} ) = \{ \begin{matrix}1 , & if \tilde{E} ( x , {𝒢}_{x} ; {f}_{θ} ) \leq ε , \\ 0 , & if \tilde{E} ( x , {𝒢}_{x} ; {f}_{θ} ) > ε ,\end{matrix}$$

where G(x, [symbol] ; ƒ_{θ}) represents a binary classification function which judges whether the input x belongs to the in-distribution data or the out-of-distribution data, ε represents a judgment threshold value, and \tilde{E}(xᵢ, [symbol] ; ƒ_{θ}) represents the final result after the energy transmission.

The samples with high energy values are considered to be out-of-distribution data input.

Furthermore, the result indicates that, the energy score update model based on the propagation mechanism may provide discrimination capability of the model for the out-of-distribution data samples through a simple propagation scheme during inference, without any additional training costs.

The carrying out out-of-distribution data identification and out-of-distribution data detection under different working conditions of a rolling bearing according to an intelligent out-of-distribution data diagnosis framework based on the energy scores includes four steps of graph construction, feature encoding, energy score detection, and energy propagation update.

The graph construction includes converting the vibration signals acquired by a sensor into graph data by means of the maximum mutual information coefficient, and constructing the adjacency matrix which reflects a nonlinear relationship among faults.

The feature encoding includes carrying out feature extraction on the graph data through adopting a GraphSage model and the weighted average attention mechanism. The GraphSage generates the node representations through aggregating the features of the neighbor nodes, and the attention mechanism strengthens weights of important neighbor features to enhance representation capability of the model.

The energy score detection includes introducing out-of-distribution data discrimination based on the energy scores, and establishing the energy function for the data points through re-defining the logits of the classifier. In-distribution data and out-of-distribution data are distinguished through calculating the energy scores, and effective out-of-distribution data fault detection is realized.

The energy propagation update includes improving generalization capability of the model in a semi-supervised learning environment, and proposes an energy score propagation mechanism based on a graph structure. The energy values are updated by means of neighbor node information and through iteratively propagating the energy scores of the nodes in the graph, and an energy difference between the in-distribution data and the out-of-distribution data is strengthened, so that accuracy of out-of-distribution data detection is increased.

An out-of-distribution fault detection system based on energy propagation and graph learning is further provided in the example, and specifically includes:
an acquisition module used for acquiring vibration acceleration signals in typical fault states, carrying out similarity calculation to obtain an adjacency matrix composed of the maximum mutual information coefficients, and taking the adjacency matrix as input in a graph neural network;
a feature extraction module used for carrying out feature extraction on the adjacency matrix through adopting a GraphSage graph convolution method, and generating each node representation;
an energy score calculation module used for connecting a model between an energy function and probability density to obtain an energy function under a GNN framework, calculating an energy score of each node, setting an energy score threshold value, and distinguishing between in-distribution data and out-of-distribution data; and
an optimization module used for enhancing out-of-distribution data confidence estimation for each node, and carrying out out-of-distribution data identification and out-of-distribution data detection under different working conditions of a rolling bearing according to an intelligent out-of-distribution data diagnosis framework based on the energy scores.

A computer device may be a server. The computer device includes a processor, a memory, an input/output interface (I/O), and a communication interface. The processor, the memory, and the input/output interface are connected through a system bus, and the communication interface is connected to the system bus through the input/output interface. The processor of the computer device is used for providing calculation and control capabilities. The memory of the computer device includes a non-volatile storage medium and an internal memory. This non-volatile storage medium stores an operating system, a computer program, and a database. The internal memory provides an environment for running of the operating system and the computer program in the non-volatile storage medium. The database of the computer device is used for storing data of a data cluster of an electric power monitoring system. The input/output interface of the computer device is used for exchanging information between the processor and external devices. The communication interface of the computer device is used for communicating with external terminals through a network connection.

Those of ordinary skill in the art may understand that realization for all or part of the flows in the above example method may be completed by instructing relevant hardware through a computer program, the computer program may be stored in a non-volatile computer-readable storage medium, and while being executed, the computer program may include the flows of the examples of the above methods. Any reference to the memory, the database, or other media which are used in the examples provided by the present invention may include at least one of a non-volatile memory and a volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, etc. The volatile memory may include a random access memory (RAM) or an external cache memory, etc. As an illustration and not a limitation, the RAM may be in many forms, such as a static random access memory (SRAM) or a dynamic random access memory (DRAM). The databases involved in the examples provided by the present invention may include at least one of relational databases and non-relational databases. The non-relational databases may include distributed databases based on blockchains, but are not limited to these. The processors involved in the examples provided by the present invention may be general-purpose processors, central processing units, graphics processors, digital signal processors, programmable logic units, data processing logic units based on quantum computing, etc., but are not limited to these.

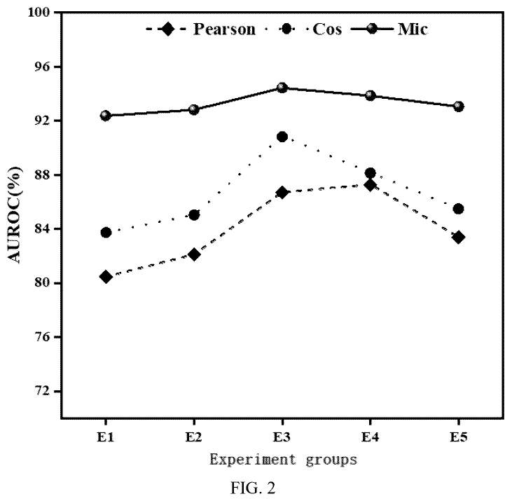

Example 2. FIG. 2 shows an example of the present invention, the example provides an out-of-distribution fault detection method and system based on energy propagation and graph learning, and in order to validate beneficial effects of the present invention, scientific demonstration is carried out through simulation experiments.

In order to simulate complex data conditions in processes of intelligent diagnosis and out-of-distribution data detection for an actual construction machinery device, a mixed data set containing different healthy states is used in a testing process for a model. Specifically, input in a training process for the model is composed of five types of data with different healthy states, namely, in-distribution data; and on the basis of the five types of in-distribution data, a type of healthy state data that is invisible in the training phase for the model, namely, out-of-distribution data, to a testing set to evaluate detection capability of the model for the out-of-distribution data. In addition, in order to validate reliability and robustness of the model, six different health states are sequentially taken as the out-of-distribution data to train and test the model for many times. Meanwhile, through carrying out the above training and testing experiments on different out-of-distribution data detection benchmark methods, superior performance of the out-of-distribution data detection method based on the energy scores is further analyzed and compared.

In selection and division for the data set, vibration signal data under six different running working conditions are truncated through sliding time windows with a length of 1024 and without an overlap between the sliding time windows in pairs, as feature information of each node, and there are a total of 500 nodes under each working condition. In addition, these node samples are randomly shuffled to guarantee that the model obtained through training has good generalization performance. In the training and testing processes for the model, a training set is composed of 2500 node samples under five different fault working conditions, while a mixed testing set includes 500 in-distribution data sample nodes from five different fault working conditions, and 100 out-of-distribution data sample nodes, and specific experiment setting information is shown in Table 1. Meanwhile, consistent learning strategy and environment are adopted for the proposed out-of-distribution data check framework and all benchmark models, a learning rate and epoch are 0.001 and 200, respectively, and all the models are realized on the basis of a PyTorch framework.

TABLE 1
Explanation of experiment groups

| | Training samples | | | | | |
|---|---|---|---|---|---|---|
| | In-distribution data | | Mixed testing samples | | Out-of-distribution | |
| | | Number | In-distribution data | | data | |
| | | of | | Number | | Number |
| | | training | | of testing | Fault | of testing |
| NO. | Fault types | samples | Fault types | samples | types | samples |
| E1 | H, F1, F2, F3, | 5 × 500 | H, F1, F2, F3, | 5 × 100 | F5 | 1 × 100 |
| | F4 | | F4 | | | |
| E2 | H, F1, F2, F3, | 5 × 500 | H, F1, F2, F3, | 5 × 100 | F4 | 1 × 100 |
| | F5 | | F5 | | | |
| E3 | H, F1, F2, F4, | 5 × 500 | H, F1, F2, F4, | 5 × 100 | F3 | 1 × 100 |
| | F5 | | F5 | | | |
| E4 | H, F1, F3, F4, | 5 × 500 | H, F1, F3, F4, | 5 × 100 | F2 | 1 × 100 |
| | F5 | | F5 | | | |
| E5 | H, F2, F3, F4, | 5 × 500 | H, F2, F3, F4, | 5 × 100 | F1 | 1 × 100 |
| | F5 | | F5 | | | |

Firstly, performance of the proposed model of the present invention in different experiment groups (E1 to E5) is comprehensively analyzed. Accuracy and reliability of intelligent diagnosis for rotary machinery are crucial for guaranteeing stable running of construction machinery devices. Different types of faults (such as external faults, internal faults, composite faults, etc.) pose different challenges to the proposed model, therefore, evaluation for the performance of the present invention under many experiment conditions is very important. Through analyzing results of the different experiment groups, a deeper understanding for capabilities and advantages of the model in dealing with diversified faults is gained. Table 2 summarizes three key evaluation indicators of five experiment groups: AUROC, AUPR, and FPR95.

TABLE 2
Evaluation indicators for EGN-out-of-distribution
data in different experiment groups

| | Out-of-distribution | | | |
|---|---|---|---|---|
| NO. | data datatype | AUROC(↑) | AUPR(↑) | FPR95(↓) |
| E1 | F5 | ≥92.36 | ≥93.51 | ≥25.43 |
| E2 | F4 | ≥92.81 | ≥93.26 | ≥25.06 |
| E3 | F3 | ≥94.42 | ≥95.62 | ≥23.11 |
| E4 | F2 | ≥93.85 | ≥94.53 | ≥23.87 |
| E5 | F1 | ≥93.04 | ≥93.79 | ≥24.74 |

The data in Table 2 clearly indicates that, the EGN-out-of-distribution data exhibits high detection capability in the various types of the out-of-distribution data, especially in an aspect of identifying F3. The data in Table 2 clearly indicates that, the EGN-out-of-distribution data exhibits high detection capability in the various types of the out-of-distribution data, especially in an aspect of identifying F3. Specifically, for the group E3, the AUROC is 94.42%, the AUPR is 95.62%, and the FPR95 is 23.11%. These indicators indicate that, the EGN-out-of-distribution data has high accuracy and precision in an aspect of identifying faults of a rolling element, and meanwhile, has a relatively low false alarm rate. Benefited from the energy score update scheme based on the data propagation mechanism and for the EGN-out-of-distribution data, the energy scores of the in-distribution nodes are guaranteed to be obviously lower than those of the out-of-distribution nodes. In addition, with the out-of-distribution data detection module based on the energy scores, the AUROC values and the AUPR values of all the experiment groups exceed 92%. It indicates that, the EGN-out-of-distribution data can keep high accuracy and precision in various fault detections. These results are of great significance for the intelligent diagnosis for the construction machinery; and the high AUROC values indicate that a normal state and a fault state can be effectively distinguished, while the high AUPR values indicate that the model has high accuracy and a high recall rate in actual fault detection, which is crucial for improving the reliability of device running. In addition, these results further indicate that, the model can not only effectively identify faults, but also greatly reduce false alarms.

Next, a routine experiment validation is carried, that is, the EGN-out-of-distribution data is compared with two types of benchmark models with regard to out-of-distribution data detection, so that superiority of the proposed model is validated. The first type of baseline models focuses on out-of-distribution data detection for processing image output, and specifically is: MSP, ODIN and Energy, and in order to ensure consistency of variables, a GNN encoder used for processing graph structure data is used for replacing an original convolutional neural network backbone. The second type of baseline models for comparison is specifically designed for processing out-of-distribution data in the field of deep graph learning, and two advanced benchmark models, that is, GPN and GKDE, are selected for the comparison.

Firstly, with regard to the out-of-distribution data detection models (MSP. ODIN and Energy) that focus on processing image output, experiment results observed that these methods have relatively low AUROC values in all the groups. The MSP method relies on probability values output by the models for detection, however, due to complex and variable vibration signals in the construction machinery, sufficient information cannot be captured. In contrast, benefited from the design of the feature encoder and the energy propagation mechanism, the AUROC values of the EGN-out-of-distribution data are significantly higher by more than 20 percentage points in the experiment groups, and especially in the group E3, the AUROC reaches 94.42, and is only 75.28 in the MSP. It indicates that the EGN-out-of-distribution data is more effective in fault identification while processing the complex vibration signals. Although the ODIN method enhances the detection capability through input perturbations and temperature scaling, robustness of the ODIN method in complex fault modes is still insufficient. The Energy method detects by means of energy values of input samples, with performance which is better than that of the MSP and the ODIN, while the proposed model still far outperforms the competitors, which further indicates the superiority of the energy-based out-of-distribution data detection model in the graph. Secondly, for the out-of-distribution data models (GPN and GKDE) in the field of deep graph learning processing, the GKDE detects through estimating probability density of a data distribution, has an AUROC which is relatively stable in all the experiment groups, but is poor in performance while processing complex vibration signals. However, the EGN-out-of-distribution data is still in better performance in all the experiment groups, and is higher in accuracy and robustness especially while processing complex rotary machinery faults.

In order to investigate performance of different encoder backbones on the proposed module based on the energy scores and the transmission mechanism, three evaluation indicators of five different backbones including MLP, JKNet, MixHop, GCN, and the proposed encoder in the experiment groups E1 to E5 are set. Experiment results show that, the different backbones do have significant influence on detection performance. Especially the GNN backbones (JKNet, MixHop, GCN, and the proposed method) are excellent in performance while processing complex topological features, and have the AUROC indicators and the AUPR indicators which are obviously better than those of the MLP. It indicates that the GNN backbones have higher capabilities in aspects of encoding and expressing topological features, and can more accurately capture the complex vibration signals in the construction machinery. Meanwhile, it also lays a solid foundation for applying a graph neural network for an out-of-distribution data detection task. Specifically, the performance of the EGN-out-of-distribution data in all the experiment groups is better than that of the other backbones. It further validates effectiveness of the energy propagation scheme of the present invention, and the scheme can sufficiently utilize topological information in the graph structure, so that the detection performance and the robustness of the model are improved. Meanwhile, under the MLP backbone, although the detection performance is relatively low, the AUROC value and the AUPR value are still close to those of the other models which use the GNN backbones, so that it indicates that the present invention is still competitive even with low feature extraction capability. It also validates effectiveness of a collaborative effect of the modules, and the energy propagation mechanism in the framework of the present invention. In contrast, when JKNet and MixHop are used as the backbones, the detection performance is significantly improved, so that it indicates that these GNN models have strong advantages in an aspect of capturing complex fault modes compared to traditional neural networks due to high topological feature encoding capability and through the energy score transmission mechanism among the nodes.

In order to validate superiority of the maximum mutual information coefficient (MIC) as a similarity measure indicator in a process of converting time sequences into graph data, a systematic experiment is carried out, and influence of three similarity measure indicators (a Pearson coefficient, a cosine similarity, and the maximum mutual information coefficient) in a composition manner is compared. An experiment result is shown in FIG. 2, and the influence of the different similarity measure indicators on the performance (AUROC) of the model is shown.

The result indicates that, graph data construction using the similarity measure indicator of the Pearson coefficient has a relatively low AUROC value in all the experiment groups, for example, the AUROC value in the group E1 is only 80.45. This is due to the fact that the Pearson correlation coefficient is mainly used for measuring a linear relationship between two variables, and the Pearson coefficient can provide good performance while processing data with linear relationships. However, rotary machinery fault data usually exhibits highly-nonlinear features, and the Pearson coefficient is difficult to capture these complex modes and hidden information. In contrast, the cosine similarity can capture nonlinear features to a certain extent while measuring vector angle relationships, and thus has an advantage in processing certain types of nonlinear data, for example, 90.87 is reached in the group E3, however, a limitation of the cosine similarity is incapability of sufficiently utilizing amplitude information of the data. Finally, the similarity measure indicator-maximum mutual information coefficient selected in the present invention is taken as a non-parameter method, any dependency relationship among variables can be measured, not limited to linear relationships or angular relationships, and then complex nonlinear relationships and potential modes in high-dimensional data can be captured, which is of great significance for comprehensive extraction and analysis for features in the rotary machinery fault data. The experiment result also clearly shows excellent performance of the MIC in the experiment groups. It also indicates that, prior knowledge of the graph topology structure may influence the performance of the model. Therefore, it is very important to select a suitable topology structure during intelligent diagnosis.

It should be noted that, the above examples are merely used for illustrating the technical solutions of the present invention and are not for limitation, although the present invention is described in detail with reference to the preferred examples, those of ordinary skill in the art should understand that, the technical solutions of the present invention may be modified or equivalently substituted without departing from the spirit and scope of the technical solution of the present invention, and all those modifications or equivalent substitutions should be included in the scope of the claims of the present invention.

What is claimed is:

1. An out-of-distribution fault detection method based on energy propagation and graph learning, comprising:
acquiring vibration acceleration signals in typical fault states, carrying out similarity calculation to obtain an adjacency matrix composed of the maximum mutual information coefficients, and taking the adjacency matrix as input in a graph neural network;
carrying out feature extraction on the adjacency matrix through adopting a GraphSage graph convolution method, and generating each node representation;
connecting a model between an energy function and probability density to obtain an energy function under a GNN framework, calculating an energy score of each node, setting an energy score threshold value, and distinguishing between in-distribution data and out-of-distribution data;
enhancing out-of-distribution data confidence estimation for each node, and carrying out out-of-distribution data identification and out-of-distribution data detection under different working conditions of a rolling bearing according to an intelligent out-of-distribution data diagnosis framework based on the energy scores;
the connecting a model between an energy function and probability density to obtain an energy function under a GNN framework comprises that, in a deep learning model, a K-class classification problem is solved by means of a parameter function ƒ_{θ}: [symbol] represents a feature space of input data x, and each data point x is a D-dimensional vector; [symbol] represents an output logits space, and each logit vector hᵢ^{(s)} is a K-dimensional vector which corresponds to K classes; ƒ_{θ} represents a parameterized mapping function, and the parameter function ƒ_{θ} maps each data point x∈ [symbol] to k real values logits; and after S layers of graph convolution, the GNN model outputs a K-dimensional vector hᵢ^{(s)} as the logits of each node, and the logits is represented as:
$${f}_{θ} ( {x}_{i} , {𝒢}_{{x}_{i}} ) = {h}_{i}^{( S )}$$
wherein ƒ_{θ}(xᵢ, [symbol] ) represents the logits obtained through carrying out S layers of graph convolution on each data point, xᵢ represents an input feature vector of the ith node, and i represents an index of the node;
according to update rules of the GNN, [symbol] represents a function for predicting logits for S-order ego-graph which takes an instance x as a center, and θ represents a trainable parameter in the GNN model ƒ;
the logits is input into a softmax function to obtain a probability distribution, and the model is enabled to carry out a classification task; and
under conditions of given x and [symbol] , a condition probability of a target class y is represented as:
$${p}_{θ} ( y \vert x , {𝒢}_{x} ) = \frac{{e}^{{{f}_{θ} ( x , {𝒢}_{x} )}_{[ y ]}}}{{\sum }_{k = 1}^{K} {e}^{{{f}_{θ} ( x , {𝒢}_{x} )}_{[ k ]}}}$$
wherein p_{θ}(y|x, [symbol] ) represents a probability that the node x is classified to be the class y, [symbol] represents a neighbor node of the node x and a connection relationship thereof, ƒ_{θ}(xᵢ, [symbol] ) represents output of the parameterized function ƒ_{θ} under an input feature x and graph structure information [symbol] , the output is a K-dimensional vector, and each component corresponds to one class of the logit; ƒ_{θ}(xᵢ, [symbol] )_{[y]} represents the yth index of ƒ_{θ}(xᵢ, [symbol] ), K represents a total number of classified classes, [y] represents an element with an index y, and [k] represents an element with an index k;
the condition probability of the target class y is combined with an EBM model between the defined energy function and the probability density, and an energy function induced by the GNN model is obtained, and represented as:
$$E ( x , {𝒢}_{x} , y ; {f}_{θ} ) = - {{f}_{θ} ( x , {𝒢}_{x} )}_{[ y ]}$$
wherein E(x, [symbol] , y; ƒ_{θ}) represents an energy value obtained through calculation;
LogSumExp(·) of the logits of a GNN classifier is re-used for defining an energy function at the data point x, and the energy function is represented as:
$${E}_{θ} ( x , {𝒢}_{x} ; {f}_{θ} ) = - Log Sum {Exp}_{k} ( {{f}_{θ} ( x )}_{[ k ]} ) = - log {\sum }_{k = 1}^{K} {e}^{{{f}_{θ} ( x , {𝒢}_{x} )}_{[ k ]}}$$
wherein E(x, [symbol] , y; ƒ_{θ}) represents the energy function, ƒ_{θ}(x)_{[k]} represents the kth element in a vector calculated by the function ƒ_{θ} under input x and [symbol] LogSumExp(·) represents a log-likelihood calculation function, and ƒ_{θ}(x, [symbol] )_{[k]} represents a component corresponding to the kth class in an output logit vector calculated by the parameterized function ƒ_{θ} under the input feature x and the graph structure information [symbol] ;
training a loss through a negative log-likelihood loss function is represented as:
$${ℒ}_{sup} = {𝔼}_{( x , {𝒢}_{x} , y ) ∼ {𝒟}_{in}^{train}} ( - log p ( y \vert x , {𝒢}_{x} ) ) = {\sum }_{i ∈ {ℐ}_{s}} ( - {{f}_{θ} ( {x}_{i} , {𝒢}_{{x}_{i}} )}_{[ {y}_{i} ]} + log {\sum }_{k = 1}^{K} {e}^{{{f}_{θ} ( {x}_{i} , {𝒢}_{{x}_{i}} )}_{[ k ]}} )$$
wherein [symbol] represents an expected value operator, Dᵢₙ^{train} represents a distribution of sampled labeled parts of training data, [symbol] represents labeled nodes, [symbol] represents a supervised training loss, ƒ_{θ}(xᵢ, [symbol] )_{[y]} represents a component corresponding to the yᵢth class in an output logit vector calculated by the parameterized function ƒ_{θ} under the input feature x and the graph structure information [symbol] , and ƒ_{θ}(xᵢ, [symbol] )_{[k]} represents a component corresponding to the kth class in an output logit vector calculated by the parameterized function ƒ_{θ} under the input feature xᵢ and the graph structure information [symbol] ;
an energy score threshold value is set, an energy score of each node is calculated according to the energy function under the GNN framework, and in-distribution data and out-of-distribution data are distinguished; and
if the energy score is lower than the threshold value, the energy score belongs to the in-distribution data, and if the energy score is higher than the threshold value, the energy score belongs to the out-of-distribution data.

2. The out-of-distribution fault detection method based on energy propagation and graph learning according to claim 1, wherein the vibration acceleration signals in the typical fault states comprise healthy H, an outer ring fault F1, an inner ring fault F2, a rolling body fault F3, an outer ring-rolling body composite fault F4, and an outer ring-inner ring-rolling body composite fault F5.

3. The out-of-distribution fault detection method based on energy propagation and graph learning according to claim 2, wherein the carrying out similarity calculation comprises that, the vibration acceleration signals B=[b₁, b₂, . . . , bₙ] and C=[c₁, c₂, . . . , cₙ] under different working conditions are acquired, and subjected to discretization processing, and converted into discrete variables;
mutual information between B and C is calculated, and variable pairs with the maximum mutual information are selected as candidates; and the mutual information I(B, C) is represented as:
$$I ( B , C ) = {\sum }_{b ∈ B} {\sum }_{c ∈ C} p ( b , c ) log \frac{p ( b , c )}{p ( b ) p ( c )}$$
wherein I(B, C) represents a mutual information coefficient, p(b, c) represents a joint probability distribution function of time sequences B and C, p(b) represents an edge probability density function of B, p(c) represents an edge probability density function of C, bᵢ represents the ith value of the time sequence B, cᵢ represents ith value of the time sequence C, and i=1, 2, . . . , n; and b represents a value of the discretized variable B, and c represents a value of the discretized variable C;
the maximum mutual information coefficient is adopted as a similarity evaluation indicator, the maximum mutual information coefficient value is obtained through carrying out normalization processing on candidate variables, a statistical quantity is defined to be a triplet (B, C, MIC), wherein B and C represent discretized versions of the input variables, and MIC represents the maximum mutual information coefficient corresponding to the discretized versions, and is represented as:
$$MIC ( B , C ) = {max}_{ℳ * 𝒩 < ξ} \frac{I ( B , C )}{{log}_{2} min ( ℳ , 𝒩 )}$$
wherein MIC(B, C) represents the maximum mutual information coefficient, [symbol] represents a number of grids divided in directions B and C, and ξ represents a selection parameter;
a dimension of the adjacency matrix composed of the maximum mutual information coefficients is N×N, and is taken as input in the graph neural network, so that one-dimensional time sequence data is converted into graph data which can be identified by the graph neural network model, and the graph data is represented as:
$$ρ = [ \begin{matrix}{p}_{11} & {p}_{12} & … & {p}_{1 N} \\ ⋮ & ⋱ & & ⋮ \\ ⋮ & & ⋱ & ⋮ \\ {p}_{N 1} & {p}_{N 2} & … & {p}_{NN}\end{matrix} ]$$
wherein ρ represents the adjacency matrix, pw represents the maximum mutual information coefficient between two time points at the Nth time of the time sequences B and C; and pᵢⱼ represents the maximum mutual information coefficient between a node i and a node j, is a similarity measure between the two nodes, and is taken as a weight coefficient of each edge, i=1, 2, . . . , N, and j=1, 2, . . . , N.

4. The out-of-distribution fault detection method based on energy propagation and graph learning according to claim 3, wherein the carrying out feature extraction on the adjacency matrix through adopting a GraphSage graph convolution method, and generating each node representation comprises that, node representations are generated through sampling and aggregating features of neighbor nodes, and a weighted average attention mechanism is introduced to carry out weighting processing on the features of the neighbor nodes, so that important feature information is highlighted;
it is assumed that hᵥ^{(s)} represents a node representation of a node v at the sth layer, C(v) represents a neighbor set of the node v, and an update formula for a node representation at the s+1th layer is:
$${h}_{v}^{( s + 1 )} = σ ( {W}^{( s )} \cdot Aggregate ( \{ {h}_{v}^{( s )} \} ⋃ \{ {h}_{u}^{( s )} , ∀ u ∈ 𝒞 ( v ) \} ) )$$
wherein hᵥ^{(s+1)} represents a node representation of the node v at the s+1th layer, σ represents a nonlinear activation function, W^{(s)} (represents a weight matrix of the sth layer, hᵤ^{(s)} represents a node representation of a node u at the sth layer, and Aggregate represents a mean value aggregation function, and is represented as:
$$Aggregate ( \{ {h}_{v}^{( s )} \} ⋃ \{ {h}_{u}^{( s )} , ∀ u ∈ 𝒞 ( v ) \} ) = \frac{1}{\vert 𝒞 ( v ) \vert + 1} {\sum }_{u ∈ \{ v \} ⋃ 𝒞 ( v )} {h}_{u}^{( s )}$$
attention weights obtained are normalized through the Softmax function to obtain aᵥᵤ, and feature aggregation is carried out through the weighted average attention mechanism to obtain an updated node representation:
$${h}_{v}^{( s + 1 )} = σ ( {\sum }_{u ∈ 𝒞 ( v )} {α}_{vu} {Wh}_{u}^{( s )} ) = σ ( {\sum }_{u ∈ 𝒞 ( v )} {α}_{vu} {W}^{( s )} ( \frac{1}{\vert 𝒞 ( v ) \vert + 1} {\sum }_{u ∈ \{ v \} ⋃ 𝒞 ( v )} {h}_{u}^{( s )} ) )$$
wherein aᵥᵤ represents a result after normalizing the attention weights, W represents the weight matrix, and h represents the node representation.

5. The out-of-distribution fault detection method based on energy propagation and graph learning according to claim 1, wherein the enhancing out-of-distribution data confidence estimation for each node comprises that, E⁽⁰⁾[E(xᵢ, [symbol] ; ƒ_{θ}) [symbol] is defined to be an initial energy score vector of a node vᵢ in a graph, E⁽⁰⁾ represents an initial energy score vector of the node vᵢ in the graph, E(xᵢ, [symbol] ; ƒ_{θ}) represents an energy function which is used for calculating an energy value of the node, and through a propagation update rule, the energy value is represented as:
$${E}^{( s )} = λ {E}^{( s - 1 )} + ( 1 - λ ) {D}^{- 1} {AE}^{( s - 1 )} , {E}^{( s )} = {[ {E}_{i}^{( s )} ]}_{i ∈ ℐ}$$
wherein 0<λ<1 represents a parameter which controls energy transmission between the node and other connected nodes to be concentrated; E^{(s)} represents an energy score vector of the node at the sth layer, E^{(s+1)} represents an energy score vector of the node at the sth layer, D represents a degree matrix, A represents the adjacency matrix, [symbol] represents all node domains, and Eᵢ^{(s)} represents an energy value of the ith node after the sth iteration;
according to a propagation rule for the updated nodes, after S-step propagation, a final result
$$\tilde{E} ( {x}_{i} , {𝒢}_{{x}_{i}} ; {f}_{θ} ) = {E}_{i}^{( S )}$$
after the energy transmission is obtained, wherein \tilde{E}(xᵢ, [symbol] ; ƒ_{θ}) represents a final energy value of the node i after S-step propagation iteration, and out-of-distribution data detection and judgment are carried out on the final result after the energy transmission;
the transmission of energy in a graph topology structure enhances out-of-distribution data confidence estimation for each node by means of the energy values of adjacent nodes, and with regard to any given data sample point xᵢ, if an average energy score
$$\frac{{\sum }_{j} {a}_{ij} {E}_{j}^{( s - 1 )}}{{\sum }_{j} {a}_{ij}}$$
of a one-hop neighbor node of the data sample point is lower than an own energy score Eᵢ^{(k-1)} of the data sample point, which is represented as:
$$\frac{{\sum }_{j} {a}_{ij} {E}_{j}^{( s - 1 )}}{{\sum }_{j} {a}_{ij}} < {E}_{i}^{( s - 1 )}$$
it is obtained according to the propagation update rule E^{(s)} that:
$$\begin{matrix}{E}_{i}^{( s )} = λ {E}_{i}^{( s - 1 )} + ( 1 - λ ) \frac{{\sum }_{j} {a}_{ij} {E}_{j}^{( s - 1 )}}{{\sum }_{j} {a}_{ij}} \\ < λ {E}_{i}^{( s - 1 )} + ( 1 - λ ) {E}_{i}^{( s - 1 )} \\ = {E}_{i}^{( s - 1 )}\end{matrix}$$
wherein Eᵢ^{(s)} represents a node energy score vector of the node i at the sth layer, aᵢⱼ represents a weight of a direct connection edge of the node i and the node j, and Eᵢ^{(s-1)} represents a node energy score vector of the node i at the s−1th layer; and
a judgment criteria of an out-of-distribution data discriminator is represented as:
$$G ( x , {𝒢}_{x} ; {f}_{θ} ) = \{ \begin{matrix}1 , & if \tilde{E} ( x , {𝒢}_{x} ; {f}_{θ} ) \leq ε , \\ 0 , & if \tilde{E} ( x , {𝒢}_{x} ; {f}_{θ} ) > ε ,\end{matrix}$$
wherein G(x, [symbol] ; ƒ_{θ}) represents a binary classification function which judges whether the input x belongs to the in-distribution data or the out-of-distribution data, ε represents a judgment threshold value, and \tilde{E}(xᵢ, [symbol] ; ƒ_{θ}) represents the final result after the energy transmission.

6. The out-of-distribution fault detection method based on energy propagation and graph learning according to claim 5, wherein the carrying out out-of-distribution data identification and out-of-distribution data detection under different working conditions of a rolling bearing according to an intelligent out-of-distribution data diagnosis framework based on the energy scores comprises four steps of graph construction, feature encoding, energy score detection, and energy propagation update;
the graph construction comprises converting the vibration signals acquired by a sensor into graph data by means of the maximum mutual information coefficient, and constructing the adjacency matrix which reflects a nonlinear relationship among faults;
the feature encoding comprises carrying out feature extraction on the graph data through adopting a GraphSage model and the weighted average attention mechanism; the GraphSage generates the node representations through aggregating the features of the neighbor nodes, and the attention mechanism strengthens weights of important neighbor features to enhance representation capability of the model;
the energy score detection comprises introducing out-of-distribution data discrimination based on the energy scores, and establishing the energy function for the data points through re-defining the logits of the classifier; and
distinguishing between the in-distribution data and the out-of-distribution data through calculating scores, and realizing effective out-of-distribution data fault detection; and
the energy propagation update comprises improving generalization capability of the model in a semi-supervised learning environment, and proposes an energy score propagation mechanism based on a graph structure; and the energy values are updated by means of neighbor node information and through iteratively propagating the energy scores of the nodes in the graph, and an energy difference between the in-distribution data and the out-of-distribution data is strengthened, so that accuracy of out-of-distribution data detection is increased.

7. An out-of-distribution fault detection system based on energy propagation and graph learning, and adopting the method according to claim 1, comprising:
an acquisition module used for acquiring vibration acceleration signals in typical fault states, carrying out similarity calculation to obtain an adjacency matrix composed of the maximum mutual information coefficients, and taking the adjacency matrix as input in a graph neural network;
a feature extraction module used for carrying out feature extraction on the adjacency matrix through adopting a GraphSage graph convolution method, and generating each node representation;
an energy score calculation module used for connecting a model between an energy function and probability density to obtain an energy function under a GNN framework, calculating an energy score of each node, setting an energy score threshold value, and distinguishing between in-distribution data and out-of-distribution data; and
an optimization module used for enhancing out-of-distribution data confidence estimation for each node, and carrying out out-of-distribution data identification and out-of-distribution data detection under different working conditions of a rolling bearing according to an intelligent out-of-distribution data diagnosis framework based on the energy scores.

8. A computer device, comprising a memory and a processor, wherein the memory stores a computer program, and the steps of the method according to claim 1 are realized when the processor executes the computer program.

9. A computer-readable storage medium, in which a computer program is stored, wherein the steps of the method according to claim 1 are realized when the computer program is executed by a processor.
